(19) United States
(12) Patent Application Publication
(10) Pub. No.: US 2020/0040566 A1
(43) Pub. Date: Feb. 6, 2020

(54) DEVICE AND METHOD FOR MANUFACTURING THREE-DIMENSIONAL SHAPE FOR CONSTRUCTION

(71) Applicant: FUTURECAST CO., LTD., Hwaseong-si (KR)

(72) Inventor: Tae-yoon PARK, Seoul (KR)

(21) Appl. No.: 16/338,542

(22) PCT Filed: Sep. 11, 2017
(86) PCT No.: PCT/KR2017/009925

§ 371 Date: Apr. 1, 2019

(30) Foreign Application Priority Data
Oct. 5, 2016 (KR) 10-2016-0128083

(51) Int. Cl. E04B 1/35; B33Y 10/00; B33Y 30/00; B33Y 50/02; E04B 1/76

(52) U.S. Cl. CPC E04B 1/35; B33Y 10/00; E04B 1/7604; B33Y 50/02; B33Y 30/00

(57) ABSTRACT

The present invention relates to an apparatus for manufacturing a 3D element of an architectural structure. The apparatus includes: a transfer arm unit installed movably along 3D locations; a material supply unit placed at one side of the transfer arm unit to supply construction materials necessary for the manufacture of the architectural element and fillers necessary for the formation of a space in the architectural element; and a control unit controlling the operations of the transfer arm unit and the material supply unit while moving in response to positional information included in data on the shape of the architectural element such that the construction materials and the fillers are stacked on a base plane where the architectural element is to be manufactured. The control unit controls the supply of the construction materials to locations corresponding to the element of the architectural structure and the supply of the fillers to locations corresponding to the space defined by the architectural element.

### TECHNICAL FIELD

The present invention relates to an apparatus and method for manufacturing a three-dimensional (3D) element of an architectural structure. More specifically, the present invention relates to an apparatus and method for manufacturing a 3D element of an architectural structure, including an irregularly shaped architectural element whose interior and exterior shapes are geometric as well as a ceiling or roof of an architectural structure), based on 3D printing technology in which subsequently removable fillers are filled in a space (for example, interior space) defined by the element (for example, wall, ceiling, roof or pillar) of the architectural structure and where construction materials for the architectural element are not stacked.

### BACKGROUND ART

With the recent rapid advances in 3D printers and their related technologies, apparatuses and methods for manufacturing various types of 3D shapes based on 3D printing technology have been developed.

Conventional 3D printers are used to manufacture 3D shapes by sequentially stacking liquid or solid filaments made of synthetic resins. However, conventional 3D printing technologies are limited in industrial application because of their limited choice of materials. In recent years, successful development of various kinds of 3D printing materials have increased the applicability of 3D printing technology to various industrial fields.

In the architectural field where concrete is cast to manufacture 3D shapes such as architectural elements, molds need to be installed for concrete casting and need to be removed after concrete curing. This process is complicated and troublesome, prolonging the entire construction period. Further, the installation and removal of molds threaten the safety of workers. In contrast, the application of 3D printing technology can avoid the need for mold installation and removal. Thus, 3D printing technology is considered as an innovative solution to the problems encountered in conventional architectural construction methods.

Under these circumstances, many techniques have been developed for constructing architectural structures (such as buildings) based on 3D printing technology in the architecture and/or civil engineering fields. For example, a method for manufacturing a 3D architectural structure or element based on 3D printing technology is disclosed in detail in Document 1.

The method disclosed in Document 1 can reduce the construction period and minimizes worker intervention during the construction period, achieving improved safety of workers, but has problems in that since printing materials cannot be stacked in air, a ceiling and roof cannot be manufactured above interior spaces of the architectural structure and an irregularly shaped architectural element including a 3D curved or inclined surface cannot be manufactured.

[Document 1] Korean Patent Publication No. 2016-0043509 (published on Apr. 21, 2016)

### DETAILED DESCRIPTION OF THE INVENTION

### Problems to be Solved by the Invention

The present invention has been made in an effort to solve the problems of the prior art and it is an object of the present invention to provide an apparatus and method for manufacturing a 3D element of an architectural structure, including an irregularly shaped architectural element whose interior and exterior shapes are geometric as well as a ceiling or roof of an architectural structure), based on 3D printing technology in which subsequently removable fillers are filled in a space (for example, interior space) defined by the element (for example, wall, ceiling, roof or pillar) of the architectural structure and where construction materials for the architectural element are not stacked.

### Means for Solving the Problems

An apparatus for manufacturing a 3D element of an architectural structure according to one aspect of the present invention includes: a transfer arm unit installed movably along 3D locations; a material supply unit placed at one side of the transfer arm unit to supply construction materials necessary for the manufacture of the architectural element and fillers necessary for the formation of a space in the architectural element; and a control unit controlling the operations of the transfer arm unit and the material supply unit while moving in response to positional information included in data on the shape of the architectural element such that the construction materials and the fillers are stacked on a base plane where the architectural element is to be manufactured, wherein the control unit controls the supply of the construction materials to locations corresponding to the element of the architectural structure and the supply of the fillers to locations corresponding to the space defined by the architectural element.

The transfer arm unit includes a pair of transfer rail modules placed opposite to each other at both sides of the base plane, a pair of vertical arm modules placed movably in forward and backward directions along the transfer rail modules and whose length is adjustable in the vertical direction, and a horizontal arm module whose both ends are connected to the corresponding vertical arm modules such that the height thereof varies depending on the length of the vertical arm modules; and the material supply unit is placed movably in right and left directions along the horizontal arm module.

The material supply unit further supplies an adhesive to bond the construction materials and the control unit controls the supply of the adhesive between the construction materials to be stacked adjacent to one another during manufacture of the architectural element.

The material supply unit further supplies a thermal insulation material to thermally insulate the architectural element; and the control unit controls the stacking of the construction materials such that thermal insulation spaces are formed in at least portions of the architectural element and the supply of the thermal insulation material to the thermal insulation spaces to form thermal insulation layers in the architectural element.

The apparatus of the present invention further includes a reinforcing bar supply unit provided integrally with or separately from the material supply unit to supply reinforcing bars to be embedded in the architectural element wherein the control unit controls the stacking of the construction materials such that spaces for insertion of the reinforcing bars are formed in at least portions of the architectural element and the supply of the reinforcing bars to the spaces for insertion of the reinforcing bars to form a reinforcing bar frame in the architectural element.

The fillers include a first filler having a predetermined volume and filling the space defined by the architectural element and a second filler filling pores between the first filler particles, and the first filler and the second filler are made of a lighter material than the construction materials to prevent the architectural element from being loaded during stacking of the construction materials.

A method for manufacturing a 3D element of an architectural structure according to another aspect of the present invention includes: stacking construction materials necessary for the manufacture of the architectural element and fillers necessary for the formation of a space in the architectural element on a base plane where the architectural element is to be manufactured while moving in response to positional information included in pre-stored data on the shape of the architectural element (first step); and removing the fillers from the interior of the architectural element (second step), wherein the construction materials are stacked at locations corresponding to the element of the architectural structure and the fillers are stacked at locations corresponding to the space defined by the architectural element in the first step.

In the first step, an adhesive is supplied between the construction materials to be stacked adjacent to one another to bond the construction materials during manufacture of the architectural element.

In the first step, the construction materials are stacked such that thermal insulation spaces are formed in at least portions of the architectural element and a thermal insulation material is supplied to the thermal insulation spaces to form thermal insulation layers in the architectural element.

In the first step, the construction materials are stacked such that spaces for insertion of reinforcing bars are formed in at least portions of the architectural element and reinforcing bars are supplied to the spaces for insertion of the reinforcing bars to form a reinforcing bar frame in the architectural element.

### Effects of the Invention

The apparatus and method of the present invention are designed to stack construction materials to manufacture a 3D element of an architectural structure based on 3D printing technology. Subsequently removable fillers are filled in a space (for example, interior space) defined by the architectural element and where the construction materials for the architectural element are not stacked such that the construction materials are stacked thereon. Due to this design, the apparatus and method of the present invention facilitates the manufacture of a ceiling or roof of an architectural structure or an interior or exterior wall or inclined plane of an irregularly shaped architectural structure with geometrically curved surfaces based on 3D printing technology, which is a problem that has been difficult to solve in the art.

### BRIEF DESCRIPTION OF THE DRAWINGS

FIG. 1 is a perspective view illustrating the constitution of an apparatus for manufacturing a 3D element of an architectural structure according to one embodiment of the present invention.

FIG. 2 is a flow diagram illustrating a method for manufacturing a 3D element of an architectural structure using the apparatus of FIG. 1.

FIGS. 3a and 3b each illustrates a method for manufacturing a roof of an architectural structure using the apparatus of FIG. 1.

FIGS. 4a and 4b each illustrates another method for manufacturing a 3D element of an architectural structure using the apparatus of FIG. 1.

FIG. 5 is a block diagram illustrating the operation of the apparatus of FIG. 1.

FIGS. 6 and 7 each illustrates a method for forming a reinforcing bar frame in an element of an architectural structure using the apparatus of FIG. 1.

### MODE FOR CARRYING OUT THE INVENTION

Preferred embodiments of the present invention will now be described in detail with reference to the accompanying drawings.

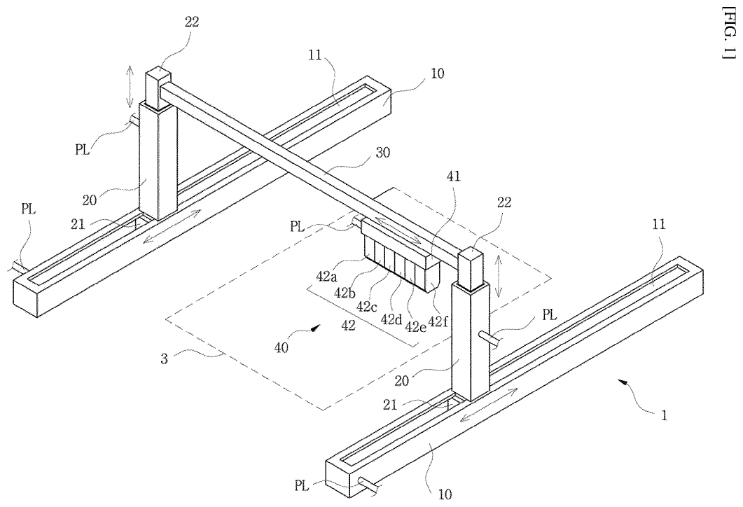

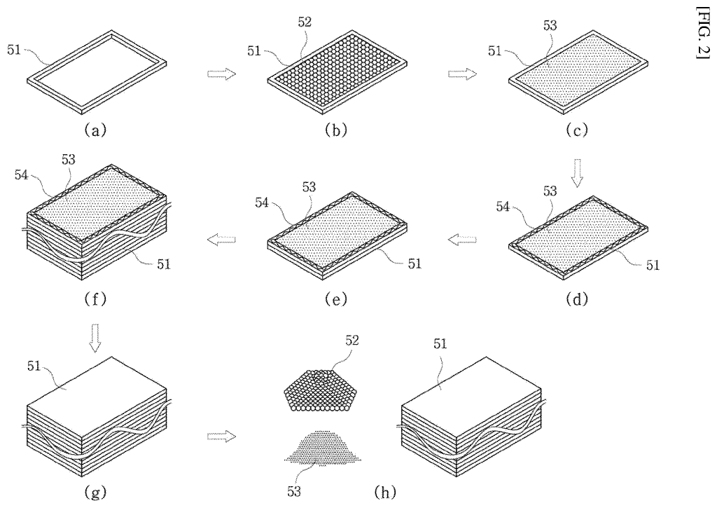

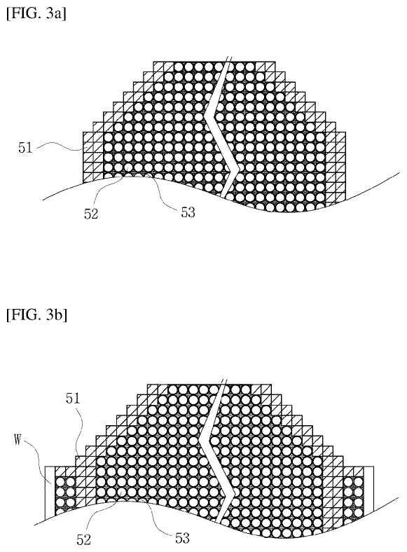

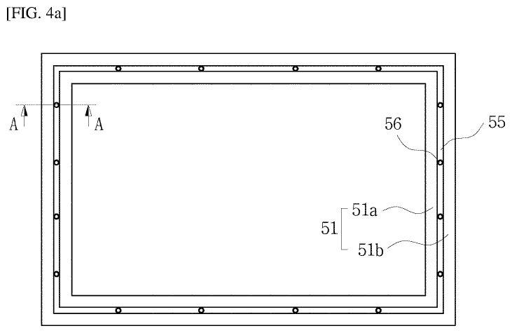

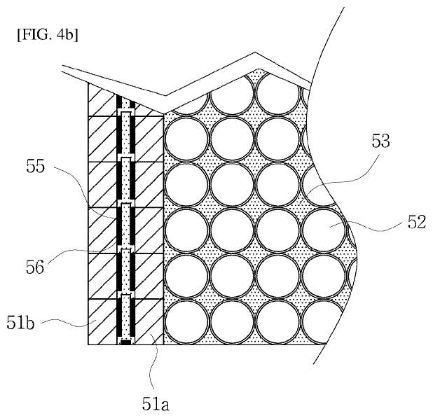

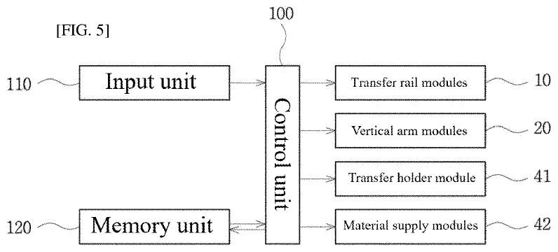

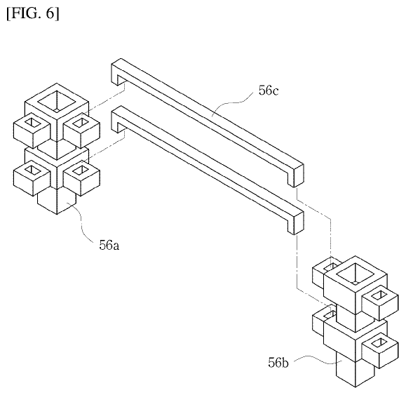

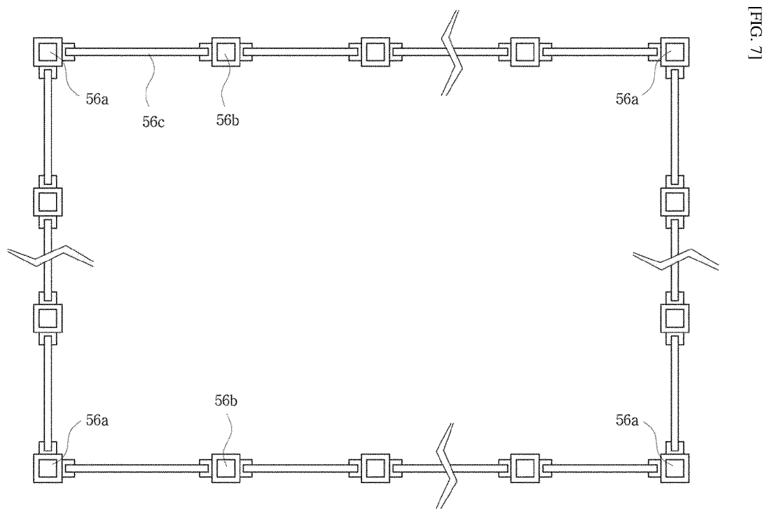

FIG. 1 is a perspective view illustrating the constitution of an apparatus for manufacturing a 3D element of an architectural structure according to one embodiment of the present invention, FIG. 2 is a flow diagram illustrating a method for manufacturing a 3D element of an architectural structure using the apparatus of FIG. 1, FIGS. 3a and 3b each illustrates a method for manufacturing a roof of an architectural structure using the apparatus of FIG. 1, FIGS. 4a and 4b each illustrates another method for manufacturing a 3D element of an architectural structure using the apparatus of FIG. 1, FIG. 5 is a block diagram illustrating the operation of the apparatus of FIG. 1, and FIGS. 6 and 7 each illustrates a method for forming a reinforcing bar frame in an element of an architectural structure using the apparatus of FIG. 1.

An apparatus for manufacturing a 3D element of an architectural structure according to the present invention includes: a transfer arm unit 1 installed movably along 3D locations; and a material supply unit 40 placed at one side of the transfer arm unit 1 to supply construction materials necessary for the manufacture of the architectural element and fillers necessary for the formation of a space in the architectural element.

In this embodiment, the transfer arm unit 1 is designed to include a pair of transfer rail modules 10 placed opposite to each other at both sides of a base plane 3, a pair of vertical arm modules 20 placed movably in forward and backward directions along the corresponding transfer rail modules 10, and a horizontal arm module 30 whose both ends are connected to the corresponding vertical arm modules. However, any design that is movable along 3D coordinates may be employed for the transfer arm unit 1.

Each of the transfer rail modules 10 has a rail slot 11 along which the corresponding vertical arm module 20 is transferred in forward and backward directions. A power supply line PL is connected to one side of each of the transfer rail modules 10 to transmit power for transferring the corresponding vertical arm module 20.

For example, the power supply line PL may be a hydraulic supply line or electric power supply line.

Each of the vertical arm modules 20 includes a lower transfer wheel 21 fitted into the rail slot 11 of the corresponding transfer rail module 10 and movable in forward and backward directions (that is, in the lengthwise direction of the transfer rail module) and an upper hydraulic or electrically driven cylinder 22 whose length is adjustable in the vertical direction; and a power supply line PL is connected to one side of the vertical arm module 20 to supply power necessary for the operation of the cylinder 22.

Both ends of the horizontal arm module 30 are coupled to the cylinders 22 of the corresponding vertical arm modules 20 so that the height of the horizontal arm modules 30 is adjustable depending on the length of the vertical arm modules 20.

The material supply unit 40 includes a transfer holder module 41 coupled to one side of the horizontal arm module 30 such that the material supply unit 40 is movable in right and left directions along the horizontal arm module 30 (that is, in the lengthwise direction of the horizontal arm module) and material supply modules 42 coupled to the transfer holder module 41 to supply materials necessary for the manufacture of the architectural element.

A transfer rail (not illustrated) is preferably placed in the coupling portion between the horizontal arm module 30 and the transfer holder module 41 to transfer the material supply unit 40. A power connecting line PL is connected to one side of the transfer holder module 41 to provide power necessary for the transfer of the material supply unit 40.

The material supply modules 42 are preferably constructed such that a plurality of kinds of materials are supplied when necessary. In this embodiment, the material supply modules 42 are constructed to include: a module 42a supplying construction materials for the manufacture of the architectural element (such as floor, wall, ceiling, roof or pillar); a module 42b supplying an adhesive to bond the construction materials; a module 42c supplying a thermal insulation material to thermally insulate the architectural element; a module 42d supplying reinforcing bars to be embedded in the architectural element; and modules 42e and 42f supplying first and second fillers to fill a space defined by the architectural element, respectively, which will be described below.

The material supply modules 42 are not limited to the construction including the modules supplying six different kinds of materials. Alternatively, it should be understood that the material supply modules 42 may be constructed to supply different kinds of materials from those used in this embodiment.

In this embodiment, the six material supply modules 42a to 42f are coupled in common to the transfer holder module 41 and are moved in conjunction cooperation with the operation of the transfer arm unit 1. Alternatively, one or more of the material supply modules may be separated from the other modules. For example, bulk reinforcing bars with high load may be supplied by a separate supply structure.

Each of the material supply modules 42 includes a housing in which the corresponding material is previously filled. Alternatively, each of the material supply module 42 may be connected to an external material source.

For example, the construction materials may be concrete, the adhesive may be mortar or any architectural adhesive known in the art, and the thermal insulation material may be a foamed material, rock wool or glass wool.

The fillers include a first filler having a predetermined volume and filling the space defined by the architectural element and a second filler filling pores between the first filler particles. The first filler and the second filler are preferably made of a material that is lighter than the construction materials while possessing sufficient strength to maintain their shapes in order to prevent the architectural element from being loaded during stacking of the construction materials, which will be described below.

For example, the fillers may be composed of a lightweight plastic material. Particularly, the first filler is preferably is composed of hollow volumetric objects.

The apparatus of the present invention is operated as follows. First, a worker inputs working conditions for manufacturing a desired architectural element and signals for working initiation. The working conditions include kinds of construction materials to be stacked, stacking rates of the construction materials, data on the shape of the architectural element, and stacking locations of the construction materials. At this time, the control unit 100 controls the operations of the transfer rail modules 10, the vertical arm modules 20, the transfer holder module 41, and the material supply modules 42 depending on a working mode (or working algorithm) pre-stored in a memory unit 120 to manufacture the architectural element.

In this embodiment, the material supply unit 40 is moved forward and backward by the transfer rail modules 10, upward and downward by the vertical arm modules 20, and rightward and leftward by the transfer holder module 41. However, the movement directions of the material supply unit 40 are merely illustrative and the present invention is not limited thereto. The material supply unit 40 may be moved in various ways as long as it performs the same functions.

The data on the shape of the architectural element refer to data on the architectural element designed using by a 3D CAD program and include 3D positional information (or coordinate information) of each node point. The apparatus illustrated in FIG. 1 may be designed such that the data on the shape of the architectural element are input in real time through an input unit 110 while working or are pre-stored in a memory unit 120.

A method for manufacturing an element of an architectural structure using the apparatus of FIG. 1 will be described in detail with reference to FIG. 2.

First, the control unit 100 controls the operations of the transfer arm unit 1 and the material supply unit 40 on a base plane 3, where the architectural element is to be manufactured, to stack construction materials 51 and fillers 52 and 53 on the base plane 3, as illustrated in FIG. 2, while moving in response to the positional information included in the data on the shape of the architectural element.

The control unit 100 controls the supply of the construction materials 51 to locations corresponding to the element (such as floor, wall, ceiling, roof or pillar) of the architectural structure and the supply of the fillers to locations corresponding to a space defined by the architectural element.

When the element of the architectural structure is manufactured, the control unit 100 may control such that the construction materials 51 are integrated with each other during drying (or curing). Alternatively, the control unit 100 controls the supply of an adhesive 54 between the construction materials 51 to be stacked adjacent to one another, as illustrated in (d) to (f) of FIG. 2. The use of the adhesive makes the architectural element more robust.

As described above, when the construction materials 51 and the fillers 52 and 53 are stacked, the space defined by the architectural element (for example, the interior space of the architectural structure) is filled with the fillers 52 and 53, enabling stacking of the construction materials 51 thereon. Accordingly, the apparatus of the present invention facilitates the manufacture of a ceiling or roof of an architectural structure or a wall or inclined plane of an irregularly shaped architectural structure with geometrically curved surfaces based on 3D printing technology, which is a problem that has been difficult to solve in the art, as illustrated in (g) of FIG. 2 and FIGS. 3a and 3b.

In the case where it is desired to manufacture an outwardly extending roof or wall of an irregularly shaped architectural structure, an auxiliary wall W may be provided outside the architectural structure, if needed, as illustrated in FIG. 3b, and the fillers 52 and 53 may be filled between the auxiliary wall W and the outer side of the architectural structure. Thereafter, the construction materials 51 are stacked to manufacture the roof or wall.

After drying (or curing) of the architectural element for a predetermined time, the fillers 52 and 53 are separated from the architectural element by lifting the architectural element upward and discharging the fillers 52 and 53 through the open bottom side. Alternatively, an opening for discharge of the fillers 52 and 53 may be previously formed when the shape of the architectural element is designed.

The control unit 100 controls the stacking of the construction materials 51a and 51b such that thermal insulation spaces are formed in at least portions of the structures of the architectural element and the supply of a thermal insulation material 55 to the thermal insulation spaces to form thermal insulation layers in the architectural element, as illustrated in FIGS. 4a and 4b.

In this case, the control unit 100 may control the supply of the thermal insulation material 55 to form thermal insulation layers whenever the construction materials 51a and 51b are stacked. Alternatively, after stacking of the construction materials 51a and 51b is completed, foams may be sprayed to form thermal insulation layers over the entire region of the thermal insulation spaces.

The control unit 100 may control the stacking of the construction materials 51a and 51b such that spaces for insertion of reinforcing bars are formed in at least portions of the architectural element and the supply of reinforcing bars 56 to the spaces for insertion of reinforcing bars to form a reinforcing bar frame in the architectural element, as illustrated in FIGS. 4a and 4b.

In this embodiment, the spaces for insertion of reinforcing bars are formed in the thermal insulation spaces. However, this is merely illustrative and the present invention is not limited thereto. For example, the thermal insulation spaces and the spaces for insertion of reinforcing bars may be formed separately.

FIGS. 6 and 7 exemplify a configuration and coupling design of reinforcing bars according to one embodiment of the present invention.

In this embodiment, the reinforcing bars 56 include first linking reinforcing bars 56a provided at edges of the architectural element, second linking reinforcing bars 56b provided between the first linking reinforcing bars, and connection reinforcing bars 56c connecting the first linking reinforcing bars 56a to the second linking reinforcing bars 56b. The coupling of the reinforcing bars 56a, 56b, and 56c in the horizontal direction, the stacking between the first linking reinforcing bars 56a in the vertical direction, and the stacking between the second linking reinforcing bars 56b in the vertical direction lead to the formation of a reinforcing bar frame.

Alternatively, a reinforcing bar connecting structure may be further applied to the coupling between the overlying and underlying connection reinforcing bars 56c. The strength of the architectural element may be reinforced in various ways different from those employed in this embodiment.

### INDUSTRIAL APPLICABILITY

The apparatus and method of the present invention are suitable for forming inclined surfaces or geometrically curved surfaces based on 3D printing technology. Therefore, the apparatus and method of the present invention can be applied to the manufacture of a large-scale architectural element or structure with a complex ceiling or geometrically curved surfaces as well as a regularly (e.g., rectangular parallelepiped) shaped large-scale architectural element or structure.

1. An apparatus for manufacturing a 3D element of an architectural structure, comprising:
a transfer arm unit installed movably along 3D locations; a material supply unit placed at one side of the transfer arm unit to supply construction materials necessary for the manufacture of the architectural element and fillers necessary for the formation of a space in the architectural element; and
a control unit controlling the operations of the transfer arm unit and the material supply unit while moving in response to positional information included in data on the shape of the architectural element such that the construction materials and the fillers are stacked on a base plane where the architectural element is to be manufactured,
wherein the control unit controls the supply of the construction materials to locations corresponding to the element of the architectural structure and the supply of the fillers to locations corresponding to the space defined by the architectural element.

2. The apparatus according to claim 1, wherein the transfer arm unit comprises a pair of transfer rail modules placed opposite to each other at both sides of the base plane, a pair of vertical arm modules placed movably in forward and backward directions along the transfer rail modules and whose length is adjustable in the vertical direction, and a horizontal arm module whose both ends are connected to the corresponding vertical arm modules such that the height thereof varies depending on the length of the vertical arm modules; and the material supply unit is placed movably in right and left directions along the horizontal arm module.

3. The apparatus according to claim 1, wherein the material supply unit further supplies an adhesive to bond the construction materials and the control unit controls the supply of the adhesive between the construction materials to be stacked adjacent to one another during manufacture of the architectural element.

4. The apparatus according to claim 3, wherein the material supply unit further supplies a thermal insulation material to thermally insulate the architectural element; and the control unit controls the stacking of the construction materials such that thermal insulation spaces are formed in at least portions of the architectural element and the supply of the thermal insulation material to the thermal insulation spaces to form thermal insulation layers in the architectural element.

5. The apparatus according to claim 4, further comprising a reinforcing bar supply unit provided integrally with or separately from the material supply unit to supply reinforcing bars to be embedded in the architectural element wherein the control unit controls the stacking of the construction materials such that spaces for insertion of the reinforcing bars are formed in at least portions of the architectural element and the supply of the reinforcing bars to the spaces for insertion of the reinforcing bars to form a reinforcing bar frame in the architectural element.

6. The apparatus according to claim 1, wherein the fillers comprise a first filler having a predetermined volume and filling the space defined by the architectural element and a second filler filling pores between the first filler particles, and the first filler and the second filler are made of a lighter material than the construction materials to prevent the architectural element from being loaded during stacking of the construction materials.

7. A method for manufacturing a 3D element of an architectural structure, comprising:
stacking construction materials necessary for the manufacture of the architectural element and fillers necessary for the formation of a space in the architectural element on a base plane where the architectural element is to be manufactured while moving in response to positional information included in pre-stored data on the shape of the architectural element (first step); and
removing the fillers from the interior of the architectural element (second step),
wherein the construction materials are stacked at locations corresponding to the element of the architectural structure and the fillers are stacked at locations corresponding to the space defined by the architectural element in the first step.

8. The method according to claim 7, wherein, in the first step, an adhesive is supplied between the construction materials to be stacked adjacent to one another to bond the construction materials during manufacture of the architectural element.

9. The method according to claim 7, wherein, in the first step, the construction materials are stacked such that thermal insulation spaces are formed in at least portions of the architectural element and a thermal insulation material is supplied to the thermal insulation spaces to form thermal insulation layers in the architectural element.

10. The method according to claim 9, wherein, in the first step, the construction materials are stacked such that spaces for insertion of reinforcing bars are formed in at least portions of the architectural element and reinforcing bars are supplied to the spaces for insertion of the reinforcing bars to form a reinforcing bar frame in the architectural element
